(19) United States
(12) Patent Application Publication
(10) Pub. No.: US 2005/0021711 A1
(43) Pub. Date: Jan. 27, 2005

(54) Router and method for activating a deactivated computer

(76) Inventors: Sepp Stieger, Augsburg (DE); Jens Horstmeier, Konigsbrunn (DE)

Correspondence Address: LERNER AND GREENBERG, PA, P O BOX 2480, HOLLYWOOD, FL, 33022-2480, US

(21) Appl. No.: 10/740,062

(22) Filed: Dec. 18, 2003

(30) Foreign Application Priority Data
Jul. 3, 2003 (DE) 103 30 079.1

(51) Int. Cl. G06F 15/173

(52) U.S. Cl. 709/223

(57) ABSTRACT

A router has a device for generating and sending a “Wake On LAN” packet to a connected local area network. The packet is already stored in the router or the router has a device for generating the packet. The invention furthermore relates to a method for activating a deactivated computer in a local area network.

### BACKGROUND OF THE INVENTION

### FIELD OF THE INVENTION

The invention relates to a router having a device for sending a “Wake On LAN” packet to a connected local area network. The invention relates to a method for activating a deactivated computer in a local area network by way of a device, with the deactivated computer having a connection to a second network by way of the device in the local area network.

In modern computer systems, it is possible to transfer the computer system from a deactivated state to an active state with a “Wake On LAN” function. A prerequisite for this is that the computer has a network interface card that is suitable for a “Wake On LAN”. A computer equipped with a function of this type may be part of a local area network containing various computers networked to one another. If the function on the network interface card is active, the computer may be powered down but remains connected to the power supply system. The specific computer is therefore only deactivated and not completely switched off. The network interface card continues to be active and receives the data traffic passing between the connected computers on the network. If the network interface card receives a “Wake On LAN” command for the computer, it activates the computer's motherboard and starts the computer. This is particularly advantageous when functions on a computer are needed only temporarily and the corresponding computer can be switched off for the remainder of the time.

A further active computer within the local area network transmits the “Wake On LAN” command either as a “broadcast packet”, i.e. as a general transmission to all computers, or as a direct packet to the deactivated computer. If the computers in the local area network are connected to the Internet by way of a router, it is conceivable to want to activate a deactivated computer within the local area network using a computer within the Internet and the router. This is necessary, for example, when a system administrator wishes to carry out remote maintenance on the services provided by the computer in the local area network.

There have hitherto been two options for externally activating a deactivated computer within a local area network using the router. A first option involves setting up a secure connection to a second active computer within the local area network and transmitting a “Wake On LAN” command to the deactivated computer from the second computer. However, at least one computer within the local area network must be active in this case. In addition, this method constitutes a possible security risk since the connection which has been set up from the Internet to the local area network may be monitored.

As an alternative thereto, it is possible to transmit a “broadcast forwarding” command to the router, the interface between the local area network and the Internet. In this case, the router receives the packet and transmits a general message to the local area network. This message contains the MAC address of the network interface card of the computer which is to be started. This address is unique for every network interface card. The network interface card compares the MAC address which has been received with its own address and activates the computer if a match is found. With this option, however, the MAC address must be known. The router must also have activated the function for forwarding a “broadcast packet.” However, activating a function of this type constitutes a security risk.

### SUMMARY OF THE INVENTION

It is accordingly an object of the invention to provide a router and a method for activating a deactivated computer which overcome the above-mentioned disadvantages of the heretofore-known devices and methods of this general type and which provide for a solution that can be used to activate a deactivated computer in the local area network.

With the foregoing and other objects in view there is provided, in accordance with the invention, a router, comprising:
a device for storing a “Wake On LAN” packet in the router and/or for generating a “Wake On LAN” packet in the router; and
a device for sending the “Wake On LAN” packet to a local area network connected to the router.

In other words, the objects are achieved by means of a router in which the “Wake On LAN” packet has already been stored or which has a device for generating a “Wake On LAN” packet. The router thus undertakes generation of the “Wake On LAN” packet and transmits it to the local area network. The security risk posed by monitoring thus no longer exists.

With the above and other objects in view there is also provided, in accordance with the invention, a method for activating a deactivated computer in a local area network, which comprises:
providing a device for activating the deactivated computer, and connecting the deactivated computer to a second network by way of the device in the local area network;
receiving, with the device, a packet intended for the deactivated computer via the second network; and
transmitting, with the device, a packet stored in the device or generated by the device to the deactivated computer in the local area network for activating the computer.

In other words, as regards the method, the objects are achieved with a device receiving a packet intended for the deactivated computer via the second network and by virtue of the device transmitting a packet generated or stored in the device to the deactivated computer in the local area network for the purposes of activation.

In this case, the router or the device transmits a “Wake On LAN” packet to the local area network. The deactivated computer's network interface card receives the packet intended for the computer and activates the latter.

It is expedient if the device for generating and sending the packet is part of an operating system for the router.

The method according to the invention may advantageously be developed by virtue of the packet received by the device being forwarded following activation of the computer. A further advantageous refinement of the method is for the device to be in the form of a router. Alternatively, the device may also be in the form of a “firewall” to protect against attacks or unauthorized ingress into the local area network.

It is particularly advantageous if a “Wake On LAN” packet is transmitted whenever the received packet requests a service and the computer providing the service is in the deactivated state. The deactivated computer is thus started, and the requested service provided, on request.

Other features which are considered as characteristic for the invention are set forth in the appended claims.

Although the invention is illustrated and described herein as embodied in a router and method for activating a deactivated computer, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a block diagram of an exemplary embodiment of the invention; and

FIG. 2 is a flowchart illustrating an exemplary embodiment of the method according to the invention.

### DESCRIPTION OF THE PREFERRED EMBODIMENTS

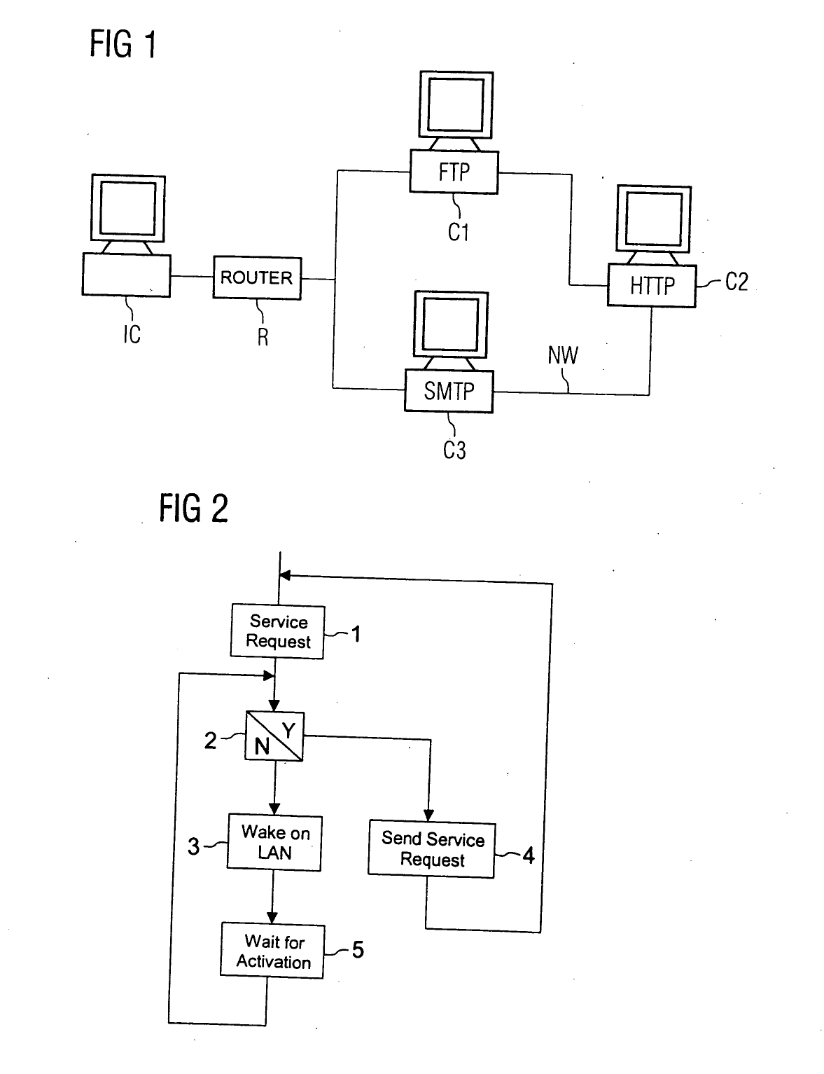

Referring now to the figures of the drawing in detail and first, particularly, to FIG. 1 thereof, there is shown a local area network NW containing three computers C1, C2 and C3 and also a router R. In addition, the router R is connected to a computer IC via a physical cable. The computer IC and the cable are part of the Internet, that is to say a computer having a temporary or fixed IP address. The computer IC will be referred to below as the external computer.

The three computers C1, C2 and C3 in the local area network NW have network interface cards (NICs) which have a unique MAC address and “Wake,On LAN” functionality. A “service” is respectively started on the three computers. The service is expressed by its respective protocol. The FTP (File Transfer Protocol) runs on the computer Cl, the computer C2 is responsible for the HTTP (HyperText Transfer Protocol) and the computer C3 contains the SMTP (Simple Mail Transfer Protocol).

The three computers may interchange data with one another and with external computers via the router.

The external computer IC then requests one of these three services. To this end, it transmits a TCP/IP packet to the router R with the request for the corresponding service. The router R analyzes this request, retrieves the MAC or IP address of the computer having the requested service from a table and translates the enquiry into the addressing for the local area network. The request is then forwarded by the router to the destination computer's address within the local area network. The destination computer processes the request and returns a response which is translated by the router and sent back to the external computer.

The computer having the requested service will now be in the deactivated state in the text which follows. FIG. 2 shows one possible example of a method in which the router reactivates the deactivated computer following a request for a service. Following an external request to the router in step 1, the latter checks, in step 2, whether or not the computer providing the requested service is active. This is usually done using a table in which the router has stored the MAC or IP addresses of the active computers in the local area network. The table also indicates which enquiry for a service is to be forwarded to which computer.

If the computer whose service is required is active, the enquiry is translated, provided with a local destination address and forwarded to the corresponding computer in step 4. If the computer is not active, the router generates a “Wake On LAN” packet in step 3. This packet contains a synchronization data stream having six bytes with the hexadecimal sequence FF, followed by 16 reiterations of the destination computer's MAC address. The packet is transmitted as a “broadcast” packet to the local area network. After a certain waiting time 5 to give the activated computer time to start the service, an enquiry is made again in order to ascertain whether the computer is active. If the computer is then active and the service has been started, the request is forwarded to the destination computer. Otherwise the process is repeated.

An external computer thus no longer has to create a “Wake On LAN” packet-and transmit it to the router, but rather the router undertakes generation and sending of the packet to the correct computer. This has the advantage that the external computer does not have to know the structure of the local area network. There is thus no need for specific knowledge of MAC addresses for the local computers or knowledge of broadcast forwarding. The potential gap in security is closed since an external computer requests a service quite normally using the router's IP address and the router ascertains the local destination address by means of the requested service. The router also undertakes activation of the computer.

In addition to a broadcast packet that is generated by the router and contains the MAC address of the computer to be activated, it is possible for the MAC address to be specified directly in the case of a fixed IP address within the local area network NW. A “Wake On LAN” function can thus be executed by the router both in the case of dynamic IP address allocation and in the case of fixed IP address assignment within the network. The corresponding “Wake On LAN” packet is transmitted whenever the computer providing the service is in the deactivated state. In addition to a router, it is also possible to carry out the method using a firewall. In addition, this also allows individual external IP addresses to be named, the IP addresses having authorization for the “Wake On LAN” function and thus increasing security even further.

1. A router, comprising:
one of a device for storing a “Wake On LAN” packet in the router and a device for generating a “Wake On LAN” packet in the router; and
a device for sending the “Wake On LAN” packet to a local area network connected to the router.

2. The router according to claim 1, wherein said device for generating and sending the “Wake On LAN” packet forms part of an operating system for the router.

3. A method for activating a deactivated computer in a local area network, which comprises:
providing a device for activating the deactivated computer, and connecting the deactivated computer to a second network by way of the device in the local area network;
receiving, with the device, a packet intended for the deactivated computer via the second network; and
transmitting, with the device, a packet stored in the device or generated by the device to the deactivated computer in the local area network for activating the computer.

4. The method according to claim 3, which comprises, following activation of the computer, forwarding the packet received by the device in the receiving step.

5. The method according to claim 3, wherein the device is a router.

6. The method according to claim 3, wherein the device is a firewall device.

7. The method according to claim 3, which comprises transmitting a packet for activation purposes to the computer only when the received packet requests a service and the computer providing the service is in the deactivated state.

8. The method according to claim 3, wherein the second network is the Internet and the received packet was transmitted by a computer connected to the Internet.
